(19) United States
(12) Patent Application Publication
(10) Pub. No.: US 2018/0187631 A1
(43) Pub. Date: Jul. 5, 2018

(54) RETRACTABLE ROCKET MOTOR IGNITER

(71) Applicant: ARIANEGROUP SAS, Paris (FR)

(72) Inventor: Gérard ROZ, Pressagny l'Orgueilleux (FR)

(73) Assignee: ARIANEGROUP SAS, Paris (FR)

(21) Appl. No.: 15/738,916

(22) PCT Filed: Jun. 21, 2016
(86) PCT No.: PCT/FR2016/051510

§ 371 Date: Dec. 21, 2017

(30) Foreign Application Priority Data
Jun. 22, 2015 (FR) 1501287

(51) Int. Cl. F02K 9/95

(52) U.S. Cl. CPC F02K 9/95; F05D 2250/41; F02K 9/64; F05D 2260/57; F05D 2260/52

(57) ABSTRACT

A rocket engine igniter 10, characterized in that it comprises a spark plug 12 that is movable between a retracted position and a deployed position, and a pressure compensation chamber 14 presenting a first internal cavity 14A and a second internal cavity 14B distinct from the first cavity, the first cavity and the second cavity being separated by at least one movable base 16, the spark plug being secured to the movable base, the first cavity communicating with a first vent 22 while the second cavity communicates with a second vent 24 that is distinct from the first vent.

### FIELD OF THE INVENTION

The present invention relates to the field of rocket engine igniters, particularly but not exclusively electric igniters, to a rocket engine combustion chamber fitted with such an igniter, and to a rocket engine fitted with such a combustion chamber.

### STATE OF THE PRIOR ART

Known igniters generally comprise a spark plug and an intermediate device between the spark plug and the combustion chamber in order to initiate combustion within the combustion chamber of the rocket engine. The spark plug initiates combustion within the intermediate device, while the intermediate device initiates combustion of the propellant(s) within a combustion chamber of the rocket engine. The intermediate device serves in particular to isolate the spark plug from the combustion chamber, thereby limiting the thermal stresses to which said spark plug is subjected.

Those known igniters present the drawback of involving a large number of components, which can be complicated to implement. Furthermore, such complexity is a source of failures, and leads to a high cost of fabrication.

### SUMMARY OF THE INVENTION

An embodiment provides a rocket engine igniter comprising a spark plug that is movable between a retracted position and a deployed position, and a pressure compensation chamber presenting a first internal cavity and a second internal cavity distinct from the first cavity, the first cavity and the second cavity being separated by at least one movable base, the spark plug being secured to the movable base, the first cavity communicating with a first vent, while the second cavity communicates with a second vent that is distinct from the first vent.

The first internal cavity communicates via the first vent, which may be an orifice for example, with the outside of the pressure compensation chamber, e.g. a first enclosure external to the igniter, e.g. a combustion chamber. Thus, by way of example, the pressure within the first internal cavity is equal to the pressure within said first enclosure external to the igniter. The second internal cavity communicates via the second vent, which may be an orifice distinct from the orifice forming the first vent, with the outside of the pressure compensation chamber, e.g. a second enclosure (distinct from the first enclosure) that is external to the igniter, e.g. an enclosure other than a combustion chamber. Thus, by way of example, the pressure within the second internal cavity is equal to the pressure within said second enclosure external to the igniter. It can be understood that the spark plug is fastened to the movable base. Thus, when the movable base moves within the pressure compensation chamber, the spark plug moves in the same manner between the deployed position and the retracted position.

It can also be understood that the base is movable within the compensation chamber as a function of the pressure difference between the first vent and the second vent. As a function of this pressure difference, the base occupies different positions, thereby driving the spark plug between the deployed position and the retracted position.

For example, the igniter may be mounted on a rocket engine so that the first vent is in fluid flow communication with the combustion chamber, while the second vent is in fluid flow communication with another enclosure within the engine, this other enclosure being at the surrounding atmospheric pressure, for example. Thus, when the rocket engine is stopped, the pressure within the first internal cavity is substantially equal to the pressure within the second internal cavity. In this configuration, the movable spark plug is in the deployed position. When the rocket engine is ignited, the combustion of propellant generates hot gas that increases the pressure within the combustion chamber, whereby the pressure within the first internal cavity increases via the first vent. Thus, the pressure difference between said first internal cavity and the second internal cavity causes the movable base to move, and consequently causes the spark plug to move within the pressure compensation chamber, the spark plug then going from the deployed position to the retracted position. In the retracted position, the movable spark plug is subjected to thermal stresses that are smaller than those to which it would be subjected in the deployed position while the rocket engine is in operation, thereby serving to avoid degrading it. Conversely, when the rocket engine is stoppedagain, the pressure within the first internal cavity decreases, such that the pressure difference between the first and second internal cavities is small enough to enable the movable spark plug to move back into the deployed position, corresponding to its position while the rocket engine is stopped. In other words, when the igniter is mounted in a combustion chamber, one of the vents is in fluid flow communication with said combustion chamber while the other vent is in fluid flow communication with some other zone, so that the extra pressure within the combustion chamber while it is in operation brings the spark plug into the retracted position, and when the combustion chamber is not in operation, the spark plug is in the deployed position.

It is thus possible to place the spark plug in a position that is suitable for initiating combustion within a combustion chamber, this position corresponding to the deployed position, for example, and in a position in which it is protected from thermal stresses within the combustion chamber, this position corresponding to the retracted position, for example. Such an igniter also presents the advantage that the rocket engine can be ignited and extinguished several times over.

In certain embodiments, the base within the pressure compensation chamber moves as from a predetermined pressure difference or pressure difference threshold. This makes it possible to ensure that the propellants are properly ignited before the spark plug is retraced. In certain embodiments, a bellows extends between the movable base and at least one wall of the pressure compensation chamber, the bellows and the movable base separating the first cavity from the second cavity within the pressure compensation chamber.

Within the pressure compensation chamber the bellows provides sealed separation between the first internal cavity and the second internal cavity, while still allowing the movable base to move, as a function of the pressure difference.

For example, the bellows is secured both to the movable base and to at least one wall of the pressure compensation chamber that does not move with respect to the base.

In certain embodiments, the bellows presents sufficient stiffness to exert a return force on the movable base, which return force tends to bring the spark plug into the retracted position or into the deployed position. By way of example, this makes it possible to ensure that the spark plug returns into the deployed position when the rocket engine is not operating.

In certain embodiments, a return spring tends to return the spark plug towards the deployed position.

For example, the return spring extends between the movable base and a wall of the pressure compensation chamber.

For example, the return spring is fastened both to the movable base, and to the wall of the pressure compensation chamber.

In general, the spring is arranged in such a manner that, as a result of the return force that it exerts on the movable base, the movable base tends to move so as to position the movable spark plug in the deployed position. Thus, when the igniter is mounted on a rocket engine, and when the rocket engine is not operating, the return spring holds the movable spark plug in the deployed position. Conversely, when the rocket engine is ignited (i.e. when there is combustion within the combustion chamber), the force exerted by the pressure difference between the first internal cavity and the second internal cavity opposes the return force of the spring. Consequently, when the pressure within the first internal cavity generates a force greater than the return force, the movable spark plug moves from the deployed position to the retracted position. By adjusting the stiffness of the spring it is possible to adjust a predetermined value for the pressure difference or for a pressure difference threshold, from which the movable base moves.

In certain embodiments, the pressure compensation chamber presents at least one abutment for limiting the movement of the base.

By way of example, said abutment is fastened to an inside surface of the pressure compensation chamber. Such an abutment makes it possible to limit the movement of the movable base to an appropriate stroke.

When the igniter also has a return spring, said abutment serves in particular to ensure that the base and the spring remain in contact, and that the spring does not move the base into an undesirable position. Under such circumstances, such an abutment contributes to ensuring the predetermined value for the pressure difference or for the pressure difference threshold when the base is in its position co-operating with the abutment.

In certain embodiments, the pressure compensation chamber has a first abutment and a second abutment, the first abutment co-operating with the base when the spark plug is in the retracted position, while the second abutment co-operates with the base when the spark plug is in the deployed position. When the igniter includes a bellows, the presence of this pair of abutments serves to limit the stroke of the base between two extreme positions to a value that is compatible with the mechanical characteristics of the bellows and of the spring, thereby avoiding them becoming flattened or stretched. Furthermore, when there is a return spring, the second abutment serves to adjust prestress of the spring to a predetermined value corresponding to the pressure threshold from which the spark plug moves into the retracted position. The first abutment also makes it possible, when the base is pressed with sufficient force against the first abutment in the retracted position, to avoid the movable spark plug performing vibratory movements under the effect of pressure fluctuations in the combustion chamber. In certain embodiments, the pressure compensation chamber extends along an axial direction, the spark plug and the base being movable along the axial direction.

This arrangement in an axial direction presents the advantage of presenting a structural configuration that is simple, reliable, and easy to fabricate.

In certain embodiments, the first vent and the second vent are arranged at opposite ends of the pressure compensation chamber along the axial direction of the chamber.

This configuration presents the advantage of making it easy to separate the pressure compensation chamber into two distinct volumes, i.e. the first internal cavity and the second internal cavity, and makes it easy to put each of these cavities into fluid flow communication with distinct external enclosures.

When the igniter is mounted on a combustion chamber, the first internal cavity is closer to the combustion chamber along the axial direction of the pressure compensation chamber, for example, and the second internal cavity is further away from the combustion chamber along the axial direction of the pressure compensation chamber, for example.

In certain embodiments, a tubular guide configured to guide the spark plug in translation between the retracted position and the deployed position, the first vent opening out into the guide.

It can be understood that a “tubular guide” may for example be a cylindrical guide of arbitrary section, e.g. of section that is circular, elliptical, polygonal, etc.

The tubular guide presents the advantage of enabling the movable spark plug to move in translation only along the axial direction of the pressure compensation chamber, thereby preventing the movable spark plug from performing any lateral movement, perpendicular to the axial direction. It can be understood that the movable spark plug moves in translation within the tubular guide along the axial directory of the guide, this axial direction of the guide coinciding with the axial direction of the compensation chamber.

In certain embodiments, the tubular guide forms a thermal protection sheet for the spark plug in the retracted position. In the retracted position, the spark plug is thus thermally protected by the guide.

In certain embodiments, a clearance is arranged between said tubular guide and the movable spark plug. Such clearance makes it possible to place the first or second vent between the guide and the spark plug, thereby enabling the guide to bring said vent and the corresponding internal cavity to the pressure of the combustion chamber.

In certain embodiments, a third vent connects the first cavity to the second cavity, the third vent being configured to limit the flow rate of fluid passing therethrough through a predetermined value.

The third vent, possibly a through hole, may be formed in the movable base, for example. The third vent thus enables the first internal cavity to be put into communication with the second internal cavity. Since the third vent is configured to limit the flow rate of fluid passing therethrough to a predetermined value, it is thus possible to adjust the pressure difference between the first and second internal cavities to a predetermined value. By way of example, this makes it possible to avoid the igniter being damaged because of potential excess pressure in a cavity.

An embodiment of the invention also provides a rocket engine combustion chamber including a rocket engine igniter in accordance with any of the embodiments described in the present disclosure, and a combustion enclosure wherein, in the deployed position, the movable spark plug extends at least in part into the inside of the combustion enclosure, while in the retracted position the movable spark plug is arranged outside the combustion enclosure.

In certain embodiments, a rocket engine combustion chamber includes a cold portion adjacent to the combustion chamber, wherein the movable spark plug extends within the cold portion in the retraced position.

The term “cold portion” designates a portion that is cooler than the combustion enclosure while the rocket engine is in operation.

This cold portion provides better thermal protection to the movable spark plug relative to the combustion chamber while said spark plug is in the retracted position.

An embodiment also provides a rocket engine including a combustion chamber in accordance with any of the embodiments described in the present disclosure.

### BRIEF DESCRIPTION OF THE DRAWINGS

The invention and its advantages can be better understood on reading the following detailed description of different embodiments of the invention given as non-limiting examples. The description refers to the sheets of accompanying figures, in which:

FIG. 1 is a diagram of a rocket engine;

FIGS. 2A and 2B show the igniter of the FIG. 1 rocket engine in greater detail, respectively in a deployed position and in a retracted position;

FIG. 3 shows a second embodiment of the rocket engine igniter; and

FIG. 4 shows a third embodiment of the rocket engine igniter.

### DETAILED DESCRIPTION OF EMBODIMENTS

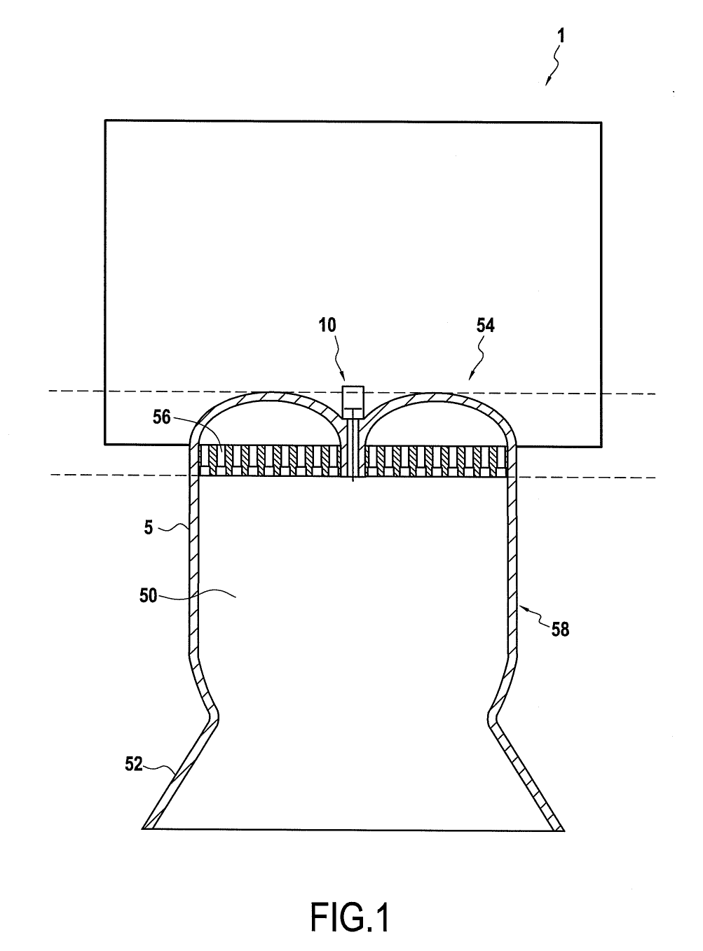

FIG. 1 shows a rocket engine 1 having a combustion chamber 5. The combustion chamber 5 comprises a combustion enclosure 50 leading to an ejection nozzle 52. The combustion chamber 5 also has an injection manifold 56 for injecting propellants into the combustion enclosure 50. A cold portion 54 arranged upstream of the injector manifold 56 receives means for bringing propellants to the row of injectors 56. Thus, the cold portion 54 is cooled by the flow of propellant before combustion. This cold portion 54 is adjacent to the combustion enclosure 50. Thus, the propellants flow from the cold portion towards the combustion enclosure via the row of injectors 56. The combustion chamber 5 has a rocket engine igniter 10 serving to initiate combustion of the propellants injected into the combustion enclosure 50 via the row of injectors 56. It can be understood that the portion of the combustion chamber 5 that receives the combustion enclosure forms the hot portion 58 of the combustion chamber 5.

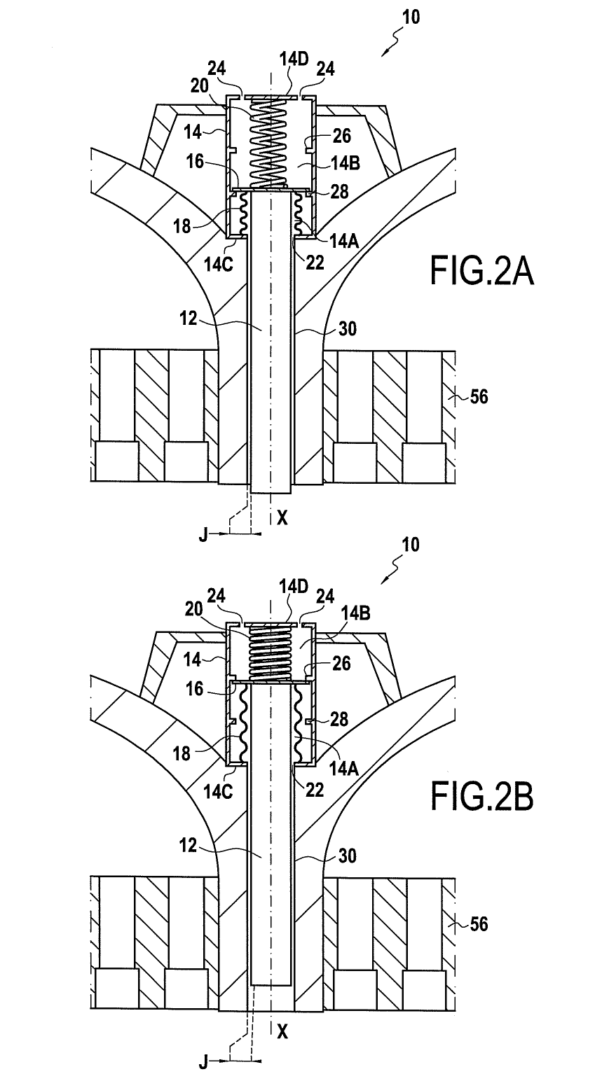

FIGS. 2A and 2B show the FIG. 1 rocket engine igniter 10 in greater detail. The rocket engine igniter 10 comprises a movable spark plug 12 that is shown in its deployed position in FIG. 2A and in its retracted position in FIG. 2B.

The rocket engine igniter 10 has a pressure compensation chamber 14 in which a movable base 16 can move in translation along an axial direction X of the pressure compensation chamber 14, the movement of the movable base 16 in the axial direction X being limited by a first abutment 26 and a second abutment 28. The movable spark plug 12 is fastened to the movable base 16 so that movement of the movable base 16 leads to identical movement of the movable spark plug 12, the movable base and the spark plug being secured to each other by means that are not shown and that are known.

In this example, a bellows 18 extends in the axial direction X between the movable base 16 and a first wall 14C of the chamber 14. The bellows is fastened both to the movable base 16 and to the wall 14C. The bellows 18 and the movable base 16 subdivide the pressure compensation chamber 14 in sealed manner into two distinct cavities, namely a first internal cavity 14A and a second internal cavity 14B, while nevertheless allowing the movable base to move.

The first internal cavity 14A communicates with a first vent 22, itself in communication with the combustion enclosure 50. The second internal cavity 14B communicates with a second vent 24, itself in communication with the outside of the combustion chamber. The first vent 22 and the second vent 24 are arranged at opposite ends of the pressure compensation chamber 14 in the axial direction X, the first vent 22 being arranged in the first wall 14C, while the second vent 24 is arranged in a second wall 14D that is opposite from the first wall 14C in the axial direction X. Naturally, it can be understood that the walls of the compensation chamber 14 do not move with respect to the base 16.

A return spring 20, in this example a compression spring, extends along the axial direction X between the movable base 16 and a second wall 14D. The return spring 20 is fastened both to the movable base 16 and to the wall 14D. The return force exerted by the spring 20 on the movable base 16, as a result of the stiffness of the spring, tends to move the base towards the second abutment 28, thereby holding the movable spark plug in a predetermined deployed position (see FIG. 2A).

The rocket engine igniter 10 also has a tubular guide 30 in which the movable spark plug 12 moves in translation along the axial direction X. Radial clearance J is arranged between the movable spark plug 12 and the tubular guide 30, while the first vent 22 opens out axially into the space that results from the clearance J. The first internal cavity 14A communicates with the combustion enclosure 50 via the first vent 22 and the tubular guide 30. Consequently, the first internal cavity 14A is at the pressure of the combustion enclosure 50.

When the rocket engine 1 is stopped, the pressure in the combustion chamber 5 is equal to the pressure outside the combustion chamber. Thus, the pressures within the first internal cavity 14A and the second internal cavity 14B are equal. As a result of the return force exerted by the spring 20 on the movable base 16, the movable spark plug 12 then remains in the deployed position (see FIG. 2A). In this configuration, the end of the movable spark plug 12 remote from the movable base 16 in the axial direction X projects into the combustion enclosure 50. When igniting the rocket engine 1, the spark plug can thus initiate combustion of propellants injected by the row of injectors 56 into the combustion chamber 5, with initiation being by means of an electric spark, for example.

During the ignition phase of the engine, the pressure within the combustion chamber increases, thereby increasing the pressure within the first internal cavity 14A, which cavity is in fluid flow communication with the combustion enclosure 50. At the same time, because of the sealed separation provided by the bellows 18 and the movable base 16, the pressure within the second internal cavity 14B remains constant and equal to the pressure outside the combustion chamber, the second internal cavity 14B communicating via the second vent 24 with the outside of the combustion chamber 5. Consequently, a pressure difference is created between the first and second internal cavities, giving rise to a force that opposes the return force of the spring 20. In this example, there are two vents 24. Naturally, there could be only one vent 24 or there could be more than two vents 24.

When the pressure within the first internal cavity generates a force greater than the return force, the movable base 16 moves so as to compress the return spring 20, with the spark plug 12 then passing from its deployed position to its retraced position (see FIG. 2B), by moving along the axial direction X until it reaches the first abutment 26. By adjusting the dimensions and the stiffness of the spring, a predetermined value is adjusted for the pressure difference or for a pressure difference threshold, from which the movable base 16 begins to move. This adjustment enables the movable spark plug 12 to remain in the deployed position at the time of igniting the rocket engine for a length of time that is sufficient to ensure that the engine ignites completely, prior to the spark plug moving into the retracted position once the ignition phase has terminated. In the retracted position, the end of the movable spark plug 12 no longer projects into the combustion enclosure 50. Said spark plug is then entirely within the cold portion 54 of the combustion chamber (FIG. 2B). The spark plug is therefore not subjected to the thermal stresses that exist within the combustion enclosure 50, and it is preserved from any thermal degradation.

When the rocket engine 1 is stopped, the pressure within the combustion enclosure 50 decreases. Beyond the pressure difference threshold, the return force exerted by the spring 20 becomes greater than the force generated by the pressure difference, thereby causing the movable spark plug 12 to go from the retracted position to the deployed position. The spark plug can then initiate combustion again.

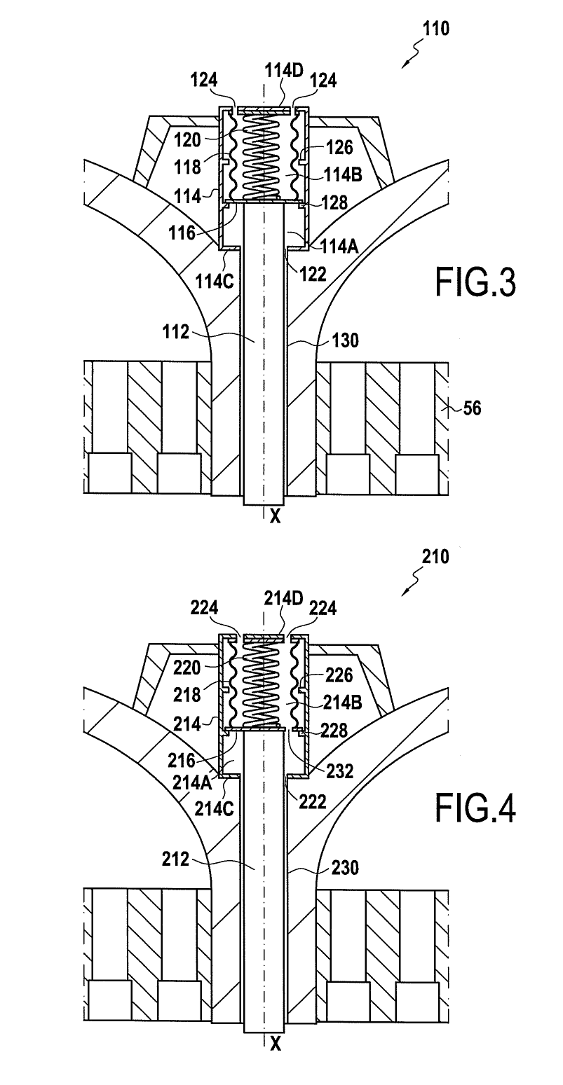

FIG. 3 shows a second embodiment of the rocket engine igniter 110. Reference signs for the various elements are incremented by 100 relative to the first embodiment. Only elements that differ are described, with elements that remain unchanged not being described again. In this second embodiment, the bellows 118 extends along the axial direction X between the movable base 116 and the second wall 114D. The bellows is fastened both to the movable base 116 and to the stationary wall of the chamber 114D. The bellows 118 and the movable base 116 separate the pressure compensation chamber 114 in sealed manner into two distinct volumes, namely a first internal cavity 114A and a second internal cavity 114B, while allowing the movable base to move.

In this example, the bellows 118 presents sufficient stiffness also to exert a return force on the movable base 116 that is not negligible compared with the force exerted by the spring 120. Naturally, the dimensions and the stiffness of the bellows 118 and of the spring 120 are taken into account together so as to adjust a predetermined value for the pressure difference or for the pressure difference threshold, beyond which the movable base moves. The operation of this igniter 110 is similar to that of the above-described igniter 10.

FIG. 4 shows a third embodiment of the rocket engine igniter 210. Reference signs of the various elements are incremented by 100 relative to the second embodiment. Only elements that differ are described, elements that remain unchanged not being described again. In this third embodiment, a third vent 232 puts the first internal cavity 214A and the second internal cavity 214B into communication, the third vent 232 being configured to limit the flow rate of fluid passing therethrough to a predetermined value.

The third vent 232, which is a through hole, is provided in the movable base 216 so as to enable the pressure within the second internal cavity 214B to be adjusted. Naturally, the section of the second vent 224 must also be taken into account for adjusting pressure in this way. This adjustment of the pressure within the second internal cavity makes it possible to select dimensions and stiffnesses for the bellows 218 and the spring 220 that serve to create the return force that is needed for holding the movable spark plug 212 in the deployed position.

Although the present invention is described with reference to specific embodiments, it is clear that modifications and changes may be undertaken to those embodiments without going beyond the general ambit of the invention as defined by the claims. In particular, individual characteristics of the various embodiments shown and/or mentioned may be combined in additional embodiments. Consequently, the description and the drawings should be considered in a sense that is illustrative rather than restrictive. For example, it is naturally possible to provide a third vent in the base of the first embodiment.

1. A rocket engine igniter, wherein the rocket engine igniter comprises a spark plug that is movable between a retracted position and a deployed position, and a pressure compensation chamber presenting a first internal cavity and a second internal cavity distinct from the first cavity, the first cavity and the second cavity being separated by at least one movable base, the spark plug being secured to the movable base, the first cavity communicating with a first vent, while the second cavity communicates with a second vent that is distinct from the first vent.

2. A rocket engine igniter according to claim 1, including a bellows extending between the movable base and at least one wall of the pressure compensation chamber, the bellows and the movable base separating the first cavity from the second cavity within the pressure compensation chamber.

3. A rocket engine igniter according to claim 1, including a return spring tending to return the spark plug towards the deployed position.

4. A rocket engine igniter according to claim 1, wherein the pressure compensation chamber presents at least one abutment for limiting the movement of the base.

5. A rocket engine igniter according to claim 1, wherein the pressure compensation chamber extends along an axial direction X, the spark plug and the base being movable along the axial direction X.

6. A rocket engine igniter according to claim 5, including a tubular guide configured to guide the spark plug in translation between the retracted position and the deployed position, the first vent opening out into the guide.

7. A rocket engine igniter according to claim 1, including a third vent connecting the first cavity to the second cavity, the third vent being configured to limit the flow rate of fluid passing therethrough through a predetermined value.

8. A rocket engine combustion chamber including a rocket engine igniter according to claim 1, and a combustion enclosure, wherein, in the deployed position, the movable spark plug extends at least in part into the inside of the combustion enclosure, while in the retracted position the movable spark plug is arranged outside the combustion enclosure.

9. A rocket engine combustion chamber according to claim 8, including a cold portion adjacent to the combustion chamber, wherein the movable spark plug extends within the cold portion in the retraced position.

10. A rocket engine including a combustion chamber according to claim 8.
